(19) United States
(12) Patent Application Publication
(10) Pub. No.: US 2025/0170734 A1
(43) Pub. Date: May 29, 2025

(54) FIXED BLADE STRUCTURE

(71) Applicant: NINGBO ICLIPPER ELECTRIC APPLIANCE CO., LTD, Ningbo, Zhejiang (CN)

(72) Inventor: Haoze WU, Ningbo, Zhejiang (CN)

(21) Appl. No.: 18/435,885

(22) Filed: Feb. 7, 2024

(30) Foreign Application Priority Data
Nov. 29, 2023 (CN) 2023232312529

(51) Int. Cl. B26B 19/38; B26B 19/06

(52) U.S. Cl. CPC B26B 19/3846; B26B 19/06

(57) ABSTRACT

A fixed blade structure includes a fixed blade body, the lower surface of the fixed blade body is attached to a movable blade; the fixed blade body further comprises a blade portion and a connecting portion, a blade end is integrally arranged at the front end of the blade portion, and the rear end of the blade portion is connected to the connecting portion; the blade end further comprises two outer blades located on two sides of the blade portion, and a plurality of middle blades evenly arranged between the two outer blades; the upper surface of the outer blade is provided with an outer convex edge, and the upper surfaces of at least a part of the middle blades are provided with first middle convex edges.

### TECHNICAL FIELD

This invention generally relates to the technical field of electric hair cutters, and more particularly, to a fixed blade structure.

### BACKGROUND

An electric hair cutter is an electric tool for cutting hair and hairdressing, typically comprising a cutter head assembly, a motor, a rotating shaft and a power supply. The cutter head assembly is the most important component, which mainly comprises a fixed cutter assembly, a movable cutter assembly and a fine adjustment mechanism. The movable cutter assembly is arranged above the fixed cutter assembly to form upper and lower rows of overlapped blades, and the fine adjustment mechanism is used for adjusting the distance between blade edges of the movable cutter assembly and the fixed cutter assembly. During operation, the fixed blade is stationary, and the movable blade quickly moves back and forth such that the hair is cut.

In the prior art, US2018218357360 discloses a movable blade structure for an electric hair cutter, wherein the movable blade structure comprises a fixed blade and a movable blade, and the fixed blade further comprises fixed-tooth blade heads and connecting sections that are sequentially connected. A plurality of fixed-tooth blade edges are arranged on the upper side of the front end of the fixed blade at intervals in the length direction of the fixed blade, and the upper end surface of the fixed-tooth blade edge is an operating surface. A plurality of movable-tooth blade edges are evenly arranged on the lower side of the front end of the movable blade at intervals in the length direction of the movable blade, and the lower end surface of the fixed-tooth blade edge is an operating surface. The movable-tooth blade edge abuts against the upper end surface of the fixed-tooth blade edge. The upper end surface of the fixed-tooth blade head is provided with a heat dissipation air opening behind the fixed-tooth blade edge, the bottom surface of the heat dissipation air opening penetrates through the lower end surface of the fixed-tooth blade head and is provided with a plurality of heat dissipation holes. The lower end surface of the movable blade is provided with exhaust blades behind the movable-tooth blade edge, and the exhaust blades are arranged in a straight line or an oblique line or a curved shape in the front-back direction.

As can be seen from the above, to improve the heat dissipation effect of the fixed blade, a plurality of heat dissipation holes are formed in the bottom surface of the heat dissipation air opening penetrating through the lower end surface of the fixed-tooth blade head. However, due to the limitation of the size and quantity of the heat dissipation holes, the processing requirement for the fixed blade becomes high, and the heat dissipation is time consuming. Under such circumstances, when the upper end surface of the fixed blade is in contact with a user's skin, a significant burning feeling is generated, making the user feel uncomfortable.

### SUMMARY

The purpose of the present invention is to provide a fixed blade structure.

To achieve the above purpose, the present invention adopts the following technical solution: a fixed blade structure comprises a fixed blade body, wherein the lower surface of the fixed blade body is attached to a movable blade; the fixed blade body further comprises a blade portion and a connecting portion, wherein a blade end is integrally arranged at the front end of the blade portion, and the rear end of the blade portion is connected to the connecting portion; the blade end further comprises two outer blades located on two sides of the blade portion, and a plurality of middle blades evenly arranged between the two outer blades; the upper surface of the outer blade is provided with an outer convex edge, and the upper surfaces of at least a part of the middle blades are provided with first middle convex edges; the outer convex edge and the first middle convex edge extend towards the connecting portion along the upper surface of the blade portion, and the upper surface of the first middle convex edge is lower than the upper surface of the outer convex edge.

In another preferred embodiment, the upper surfaces of at least a part of the middle blades are provided with second middle convex edges, the second middle convex edge extends towards the connecting portion along the upper surface of the blade portion, and the upper surface of the second middle convex edge is flush with the upper surface of the outer convex edge.

In another preferred embodiment, the first middle convex edge and the second middle convex edge are arranged in a staggered manner.

In another preferred embodiment, the first middle convex edge and the second middle convex edge are arranged in a staggered manner one by one.

In another preferred embodiment, a first groove is formed between the outer convex edge and the first middle convex edge, and a second groove is formed between the first middle convex edge and the second middle convex edge.

In another preferred embodiment, the first middle convex edge, the second middle convex edge and the outer convex edge extend obliquely upward from the blade end toward the connecting portion.

In another preferred embodiment, the longitudinal section of the first middle convex edge and/or the longitudinal section of the second middle convex edge are configured to be trapezoidal.

In another preferred embodiment, the connecting portion is provided with mounting holes.

In another preferred embodiment, the lower surface of the blade portion is provided with a sliding chute for guiding the movable blade to slide back and forth relative to the blade portion.

In another preferred embodiment, the lower surface of the middle blade is provided with an oil storage groove.

Compared with the prior art, the present invention has the following advantages:

During use, the blade end of the blade portion allows the hairs to come in; because the upper surface of the first middle convex edge is lower than the upper surface of the outer convex edge, the first middle convex edge is not in contact with a user's skin, and only the outer convex edge and the second middle convex edge are in contact with the user's skin, which significantly reduce the contact area between the upper surface of the fixed blade body and the user's skin; meanwhile, the heat transferred to the user's skin during the operation of the fixed blade body and the movable blade is significantly reduced, so that a burning feeling of the user's skin is avoided, the comfort is improved, and a convenient processing of the fixed blade body is achieved.

### BRIEF DESCRIPTION OF THE DRAWINGS

FIG. 1 is a schematic diagram illustrating an exemplary structure of the blade portion of the present invention;

FIG. 2 is a schematic diagram illustrating an exemplary structure of the blade portion of the present invention from another viewing angle;

FIG. 3 is a schematic diagram illustrating a bottom view of the blade portion of the present invention;

FIG. 4 is a schematic diagram illustrating an enlarged structure of portion A in FIG. 2;

In Figures:

1—Fixed Blade Body, 2—Blade Portion, 3—Connecting Portion, 4—Blade End, 5—Outer Blade, 6—Middle Blade, 7—Outer Convex Edge, 8—The First Middle Convex Edge, 9—The Second Middle Convex Edge, 10—The First Groove, 11—The Second Groove, 12—Mounting Hole, 13—Sliding Chute, 14—Oil Storage Groove.

### DETAILED DESCRIPTION

Drawings are combined hereinafter to further elaborate the technical solution of the present invention.

The present invention provides a fixed blade structure.

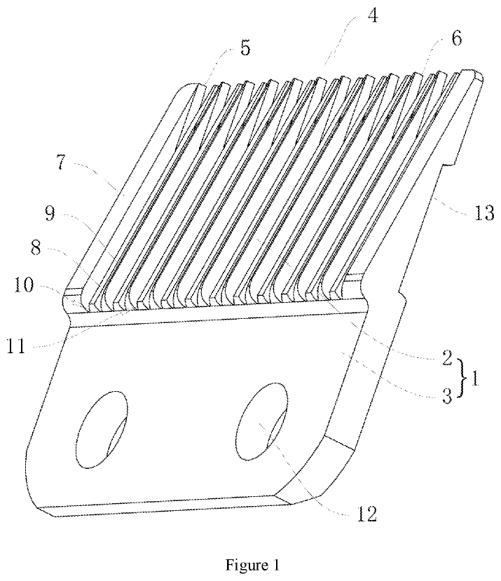

Referring to FIG. 1, the fixed blade structure of the present invention comprises a fixed blade body 1, wherein the lower surface of the fixed blade body 1 is attached to a movable blade. The fixed blade body 1 further comprises a blade portion 2 and a connecting portion 3, wherein a blade end 4 is integrally arranged at the front end of the blade portion 2, and the rear end of the blade portion 2 is integrally connected to the connecting portion 3. The blade end 4 further comprises two outer blades 5 located on two sides of the blade portion 2, and a plurality of middle blades 6 evenly arranged between the two outer blades. Gaps are formed between an outer blade 5 and a middle blade 6, as well as between every two adjacent middle blades 6.

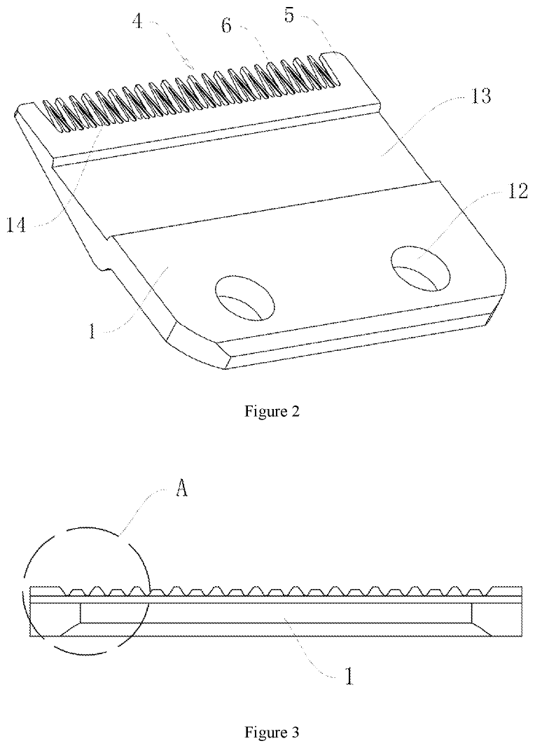

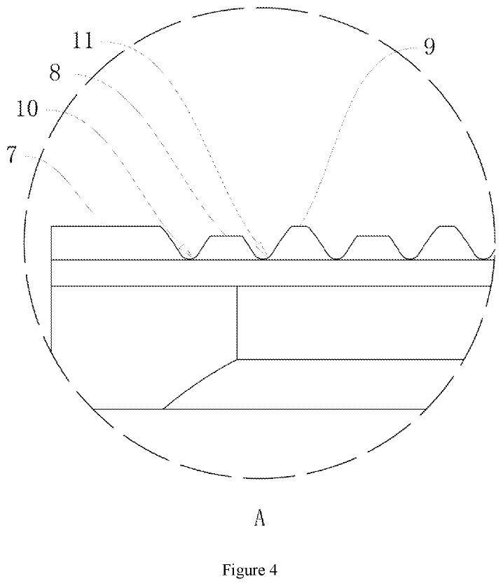

Referring to FIGS. 2 and 3, the upper surface of the outer blade 5 is integrally provided with an outer convex edge 7, and the upper surfaces of the plurality of middle blades 6 are respectively integrally provided with a plurality of first middle convex edges 8 and a plurality of second middle convex edges 9. The first middle convex edge 8 and the second middle convex edge 9 are arranged in a staggered manner one by one, the outer convex edge 7, the first middle convex edge 8 and the second middle convex edge 9 extend towards the connecting portion 3 along the upper surface of the blade portion 2. The upper surface of the first middle convex edge 8 is lower than the upper surface of the outer convex edge 7, and the upper surface of the second middle convex edge 9 is flush with the upper surface of the outer convex edge 7. The first middle convex edge 8 is not in contact with a user's skin, and the outer convex edge 7 and the second middle convex edge 9 are in contact with the user's skin, thereby reducing the contact area between the upper surface of the fixed blade body 1 and the user's skin.

The lower surface of the middle blade 6 is provided with an oil storage groove 14, the lower surface of the middle blade 6 is configured to be an isosceles triangle shape, and the oil storage groove 14 is configured to be a water-drop shape. Lubricating oil is fed in the oil storage groove 14, so that the friction between the movable blade and the fixed blade body 1 is alleviated, the load current is reduced, and the temperature rise of the blade surface is lowered.

The first middle convex edge 8, the second middle convex edge 9 and the outer convex edge 7 extend obliquely upward from the blade end 4 toward the connecting portion 3. The thickness of the blade portion 2 extending from the blade end 4 toward the connecting portion 3 gradually increases. In this way, when the fixed blade body 1 operates, the upper surface of the blade portion 2 of the fixed blade body 1 may be attached to the user's skin, allowing the hairs to be conveniently cut off.

A first groove 10 is formed between the outer convex edge 7 and the first middle convex edge 8, a second groove 11 is formed between the first middle convex edge 8 and the second middle convex edge 9, and the longitudinal section of the first groove 10 and the longitudinal section of the second groove 11 are configured to be V-shaped. The arrangement of the first groove 10 and the second groove 11 allows the area of the upper surface of the blade portion 2 to increase, thereby improving the heat dissipation effect of the blade portion 2.

In this embodiment, the longitudinal sections of the first middle convex edge 8 and the second middle convex edge 9 are configured to be trapezoidal, and the longitudinal distance of the upper surface of the first middle convex edge 8 is twice the longitudinal distance of the upper surface of the second middle convex edge 9.

The area of the upper surface of the second middle convex edge 9 is small, achieving smaller contact area with the user's skin. Meanwhile, the heat that is generated by the fixed blade body 1 and the movable blade and is transferred to the user's skin is reduced. Definitely, in some embodiments, only the longitudinal section of the first middle convex edge 9 is configured to be trapezoidal, or only the longitudinal section of the second middle convex edge 9 is configured to be trapezoidal.

Referring to FIG. 1, two mounting holes 12 are uniformly formed in two corresponding side plates of the connecting portion 3.

The lower surface of the blade portion 2 is provided with a sliding chute 13 for guiding the movable blade to slide back and forth relative to the blade portion 2.

The above are merely preferred embodiments of the present invention, and therefore, all equivalent changes or modifications made according to the structures, features and principles described in the present invention shall fall into the scope defined by the claims of the present invention.

1. A fixed blade structure, comprising:
a fixed blade body (1), wherein the lower surface of the fixed blade body (1) is attached to a movable blade, wherein the fixed blade body (1) further comprises:
a blade portion (2) and a connecting portion (3), wherein a blade end (4) is integrally arranged at the front end of the blade portion (2), and the rear end of the blade portion (2) is connected to the connecting portion (3), wherein the blade end (4) further comprises:
two outer blades (5) located on two sides of the blade portion (2), and a plurality of middle blades (6) evenly arranged between the two outer blades, wherein an upper surface of the outer blade (5) is provided with an outer convex edge (7), and upper surfaces of at least a part of the middle blades (6) are provided with first middle convex edges (8), wherein the outer convex edge (7) and the first middle convex edge (8) extend towards the connecting portion (3) along an upper surface of the blade portion (2), and an upper surface of the first middle convex edge (8) is lower than an upper surface of the outer convex edge (7).

2. The fixed blade structure of claim 1, wherein upper surfaces of at least a part of the middle blades (6) are provided with second middle convex edges (8), the second middle convex edge (7) extends towards the connecting portion (3) along the upper surface of the blade portion (2), and an upper surface of the second middle convex edge (9) is flush with the upper surface of the outer convex edge (7).

3. The fixed blade structure of claim 2, wherein the first middle convex edge (8) and the second middle convex edge (9) are arranged in a staggered manner.

4. The fixed blade structure of claim 3, wherein the first middle convex edge (8) and the second middle convex edge (9) are arranged in a staggered manner one by one.

5. The fixed blade structure of claim 2, wherein a first groove (10) is formed between the outer convex edge (7) and the first middle convex edge (8), and a second groove (11) is formed between the first middle convex edge (8) and the second middle convex edge (9).

6. The fixed blade structure of claim 2, wherein the first middle convex edge (8), the second middle convex edge (9) and the outer convex edge (7) extend obliquely upward from the blade end (4) toward the connecting portion (3).

7. The fixed blade structure of claim 2, wherein the longitudinal section of the first middle convex edge (8) and/or the longitudinal section of the second middle convex edge (9) are configured to be trapezoidal.

8. The fixed blade structure of claim 1, wherein the connecting portion is provided with mounting holes.

9. The fixed blade structure of claim 1, wherein lower surface of the blade portion (2) is provided with a sliding chute (13) for guiding the movable blade to slide back and forth relative to the blade portion (2).

10. The fixed blade structure of claim 2, wherein a lower surface of the middle blade (6) is provided with an oil storage groove (14).
